(19) United States
(12) Patent Application Publication
(10) Pub. No.: US 2021/0108748 A1
(43) Pub. Date: Apr. 15, 2021

(54) QUICK CONNECTOR FOR PLASTIC PIPE

(71) Applicant: TAIZHOU NEW SANHE SANITARY WARE CO., LTD., Zhejiang (CN)

(72) Inventor: Xinfa HUANG, Zhejiang (CN)

(73) Assignee: TAIZHOU NEW SANHE SANITARY WARE CO., LTD., Zhejiang, CHINA

(21) Appl. No.: 17/022,052

(22) Filed: Sep. 15, 2020

Related U.S. Application Data
(63) Continuation of application No. PCT/CN2020/070176, filed on Jan. 3, 2020.

(30) Foreign Application Priority Data
Oct. 12, 2019 (CN) 201921709080.2

(51) Int. Cl. F16L 37/091; F16L 43/00

(52) U.S. Cl. CPC F16L 37/0915; F16L 43/008

(57) ABSTRACT

A quick connector for plastic pipe includes a pipe-shaped body and a quick-connect structure. The quick-connect structure includes a mounting pipe and a sealing ring. A gasket, a circlip and a covering ring are sequentially disposed in the mounting pipe. The sealing ring is pressed to be fixed between the pipe-shaped body and the gasket, the covering ring is fixedly disposed in the mounting pipe. A stopping ring coaxially extends on an inner side of the covering ring. The stopping ring is sleeved on an unlocking cylinder such that the unlocking cylinder is slidable relative to the stopping ring. An abutting ring coaxially extends on an outer wall of the unlocking cylinder with a chamfer being disposed at one end of the abutting ring facing the pipe-shaped body, and a pushing ring extends coaxially on the outer wall of the unlocking cylinder at one end outside the mounting pipe.

### CROSS-REFERENCE TO RELATED APPLICATION

The present application is a continuation of international application of PCT application No. PCT/CN2020/070176 filed on Jan. 3, 2020, which claims the priority benefit to Chinese application No. 201921709080.2 filed on Oct. 12, 2019. The entirety of each of the above mentioned patent applications is incorporated herein by reference and made a part of this specification.

### BACKGROUND

### Technical Field

This application relates to a technical field of connection of a pipe, and more particularly, to a quick connector for a plastic pipe.

### Description of Related Art

A pipe is common apparatus in daily production and life, which is mainly used for the transmission of a flowing medium such as water and air.

Chinese publication No. CN204739347U discloses a quick connector for a pipe which includes a pipe-shaped body and a sealing ring embedded in the pipe-shaped body. A tapering cover is disposed on the outside of the pipe-shaped body. An annular gasket, an annular circlip and a covering tube are sequentially disposed in the tapering cover. A sleeve is sleeved in the covering tube such that the sleeve is slidable relative to the covering tube. The annular gasket presses against the sealing ring to fix the sealing ring in the pipe-shaped body.

When the pipe is assembled, an end of the pipe is inserted into the sleeve until abutting against an inner wall of the pipe-shaped body, the annular circlip abuts against an outer wall of the pipe so as to lock the pipe and prevent the pipe from moving, and the sealing ring abuts against the outer wall of the pipe so as to achieve sealing between the pipe and the pipe-shaped body.

When the pipe is disassembled, the sleeve is pushed to push the annular circlip until the circlip is opened, and the annular circlip is separated from the outer wall of the pipe, which facilitates the pull-out of the pipe and achieves the disassembly between the pipe and the pipe-shaped body.

The above existing technical solution has the following drawbacks.

A process of producing the tapering cover can only be applied to a pipe-shaped structure made of metal. When the above quick connector for the pipe is assembled, one end of the tapering cover is gradually narrowed, and the other end thereof is cylindrical. The covering tube, sleeve, annular circlip, annular gasket and the pipe-shaped body assembled with the sealing ring are sequentially placed into the cylindrical end of the tapering cover which is then processed to be tapered. The thickness of the sleeve is determined by the distance between the covering tube and the pipe due to the above process, and it is usually to select the covering tube as small as possible under the premise of matching with the pipe, such that the sleeve is thin. When the pipe is disassembled, it is difficult to push the sleeve manually as the sleeve is thin and the sleeve is attached to the pipe, which needs to be improved.

### SUMMARY

This application provides a quick connector for a plastic pipe which facilitates disassembly of a pipe by manually pushing a pushing ring so as to push an unlocking cylinder to open a circlip.

A quick connector for a plastic pipe includes a pipe-shaped body. A quick-connect structure is disposed at at least one end of the pipe-shaped body in an axis direction. The quick-connect structure includes a mounting pipe integrally formed with the pipe-shaped body and a sealing ring, a gasket, a circlip and a covering ring sequentially disposed in the mounting pipe. The sealing ring is pressed to be fixed between the pipe-shaped body and the gasket. The covering ring is fixedly disposed in the mounting pipe. A stopping ring coaxially extends on an inner side of the covering ring, and the stopping ring is sleeved on an unlocking cylinder such that the unlocking cylinder is slidable relative to the stopping ring. An abutting ring coaxially extends on an outer wall of the unlocking cylinder with a chamfer being disposed at one end of the abutting ring facing the pipe-shaped body, and a pushing ring extends coaxially on the outer wall of the unlocking cylinder at one end that is outside the mounting pipe.

When the unlocking cylinder is mounted, the pushing ring is pushed such that the abutting ring presses against the stopping ring, and the unlocking cylinder is embedded in the covering ring under the pressing force acting on the unlocking cylinder as the plastic material has good elastic deformation ability within a certain range and the guidance of the chamfer of the abutting ring. When the unlocking cylinder is pulled out of the covering ring, the stopping ring stops the abutting ring, thereby achieving stable mounting of the unlocking cylinder in the covering ring, and the pushing ring of the unlocking cylinder located outside the covering ring facilitates pushing of the unlocking cylinder during the subsequent disassembly of the pipe by hand so as to facilitate the disassembly of the pipe.

Further, a stepped ring which abuts against the gasket coaxially extends on an inner wall of the mounting pipe at one end thereof close to the pipe-shaped body, the inner wall of the mounting pipe has an engaging slot located at one end that is far away from the pipe-shaped body. A limit ring engaging with the engaging slot is disposed at on an outer periphery of the covering ring with a chamfer disposed at one end of the limit ring facing the pipe-shaped body.

When the covering ring is mounted, as the plastic material has good elastic deformation ability within a certain range, the covering ring is directly pressed to move toward the mounting pipe, the chamfer of the limit ring guides the covering ring to be embedded in the mounting pipe, thereby achieving the stable mounting of the mounting pipe. When the quick-connect structure is assembled, the stepped ring abuts against the gasket, thereby ensuring that the gasket supports the circlip and achieving the stable cooperation between the covering ring and the gasket so as to press the circlip tightly, which avoids the deviation of an axis of the circlip and ensures the stability of mounting of the pipe.

Further, a chamfer is disposed on an inside of the end of the mounting pipe that is far away from the pipe-shaped body.

When the covering ring is mounted, the covering ring is directly pressed to move toward the mounting pipe, the chamfer of the mounting pipe facilitates guiding an axis of the covering ring to coincide with an axis of the mounting pipe.

Further, the limit ring comprises limit strips spaced apart in a circumferential direction, and force-reducing grooves are formed between the limit strips.

Force-reducing grooves are formed between the limit strips and reduce the area of resistance acting on the covering ring when the covering ring is mounted in the mounting pipe, thereby facilitating the mounting of the covering ring.

Further, a diameter of the sealing ring is greater than a length of the stepped ring in the axis direction.

When the quick-connect structure is assembled, the gasket presses against the sealing ring, so as to ensure that the sealing ring is pressed to be fixed in the mounting pipe. When the pipe-shaped body receives the pipe, the sealing ring is pressed stably outside the pipe so as to improve the sealing between the sealing ring and the pipe.

Further, an arc chamfer is disposed on an outside of the unlocking cylinder at one end thereof close to the circlip.

When the pipe needs to be disassembled, the unlocking cylinder is pressed to slide toward the covering ring. First, the arc chamfer of the unlocking cylinder abuts against the circlip, and the circlip is gradually bent and opened as the unlocking cylinder gradually slides into the covering ring until the circlip is bent to abut against the abutting ring. At the same time, the circlip is separated from the arc chamfer of the unlocking cylinder, such that a force arm for pushing the circlip to rotate by the unlocking cylinder is instantly reduced, and then force required for pushing the unlocking cylinder is instantly increased, that is, a person pushing the unlocking cylinder knows that the pushing of the unlocking cylinder is completed by a sudden change in the force acting on the hand, thereby avoiding excessive pushing of the unlocking cylinder which ensures a service life of the circlip.

Further, a chamfer is disposed on an inside of the unlocking cylinder at one end that is far away from the mounting pipe.

When the pipe is assembled, the pipe is inserted into the unlocking cylinder, and the chamfer of the unlocking cylinder facilitates guiding an axis of the pipe to coincide with an axis of the unlocking cylinder, so as to facilitate the insertion of the pipe.

Further, a positioning ring extends coaxially on an inside of the pipe-shaped body.

When the pipe is assembled, the pipe is inserted into the unlocking cylinder until the pipe is inserted to abut against the positioning ring which determines the insertion depth of the pipe, thereby ensuring the stability of the connection between the pipe and the pipe-shaped body.

Further, the quick-connect structures are disposed on both ends of the pipe-shaped body in the axis direction. The pipe-shaped body is bent.

The quick-connect structures are disposed at both ends of the pipe-shaped body to facilitate the connection in a sealing way between two pipes. In the actual connection between the pipes, there is a certain inclined angle between different pipes, and different pipes with different inclined angles therebetween are connected in a sealing way by the bent pipe structure.

Further, a fixing ring extends coaxially on an outside of the covering ring with a chamfer being disposed at one end of the fixing ring facing the mounting pipe, the covering ring is embedded in the mounting pipe, and the fixing ring abuts against the mounting pipe and the two are fixed to each other by welding.

The fixing ring and the mounting pipe are fixed to each other by welding, so as to achieve the strength of the connection between the covering ring and the mounting pipe.

In summary, this application has the following beneficial effect.

When the pipe is disassembled, the pushing ring is manually pushed until the circlip presses against the abutting ring, the force required for pushing the unlocking cylinder is suddenly increased, and then the pipe is pulled out of the unlocking cylinder, thereby ensuring the smooth disassembly of the pipe.

By changing the position where the unlocking cylinder abuts against the circlip, force required for pushing the unlocking cylinder manually is suddenly increased, thereby avoiding excessive pushing of the unlocking cylinder which ensures a service life of the circlip.

The abutting ring of the unlocking cylinder is limited by the stopping ring of the covering ring so as to prevent the unlocking cylinder from separating.

The unlocking cylinder can provide guidance for assembling and disassembling the pipe, and the unlocking cylinder is manually pushed to achieve quick disassembly of the pipe.

### BRIEF DESCRIPTION OF THE DRAWINGS

FIG. 1 is an exploded schematic diagram of Embodiment One;

FIG. 2 is a half sectional view of Embodiment One;

FIG. 3 is a half sectional view of a double-end quick-connect structure of Embodiment One;

FIG. 4 is a half sectional view of a bent pipe structure of Embodiment One;

FIG. 5 is an exploded schematic diagram of Embodiment Two; and

FIG. 6 is a half sectional view of Embodiment Two.

### DESCRIPTION OF THE EMBODIMENTS

This application is described in detail below in combination with the drawings.

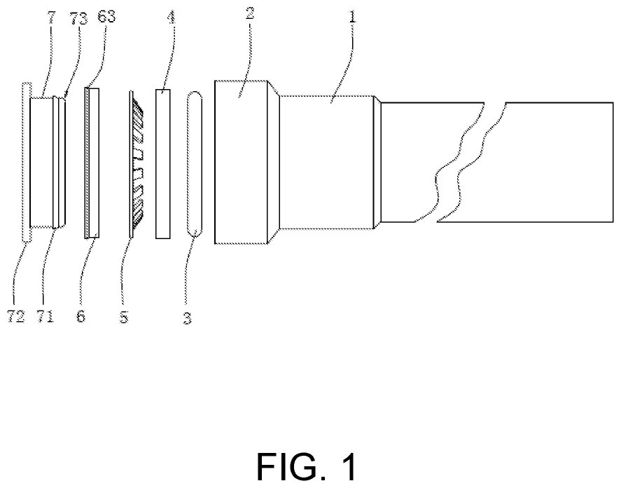

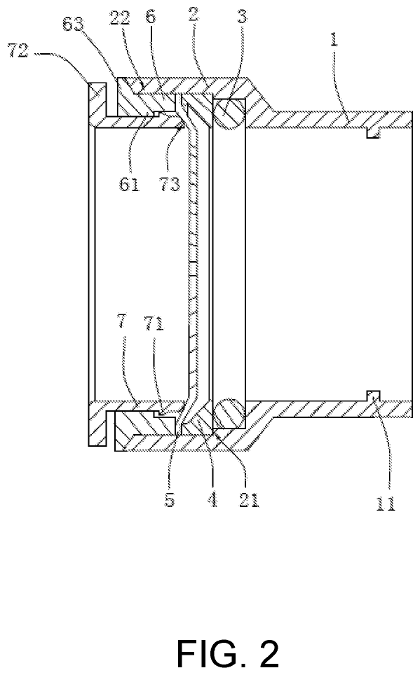

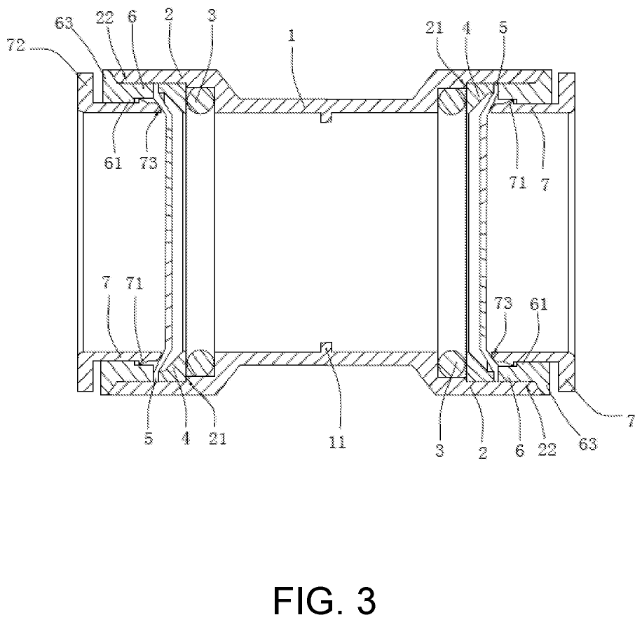

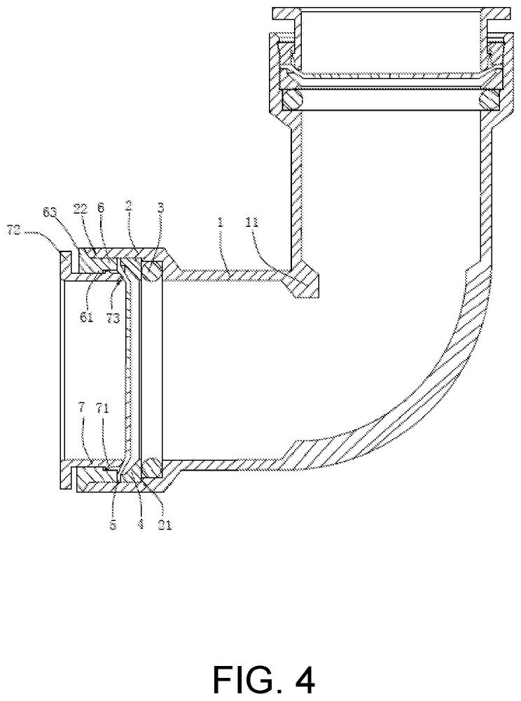

As shown in FIG. 1 to FIG. 4, a quick connector for a plastic pipe is made of plastic. The quick connector includes a pipe-shaped body 1, which may be straight, bent and so on, and a quick-connect structure is disposed at one or both ends of the pipe-shaped body 1 for quick disassembly and assembly of a pipe. The quick-connect structure includes a mounting pipe 2 coaxially and integrally formed with the pipe-shaped body 1, and an inner diameter of the mounting pipe 2 is larger than that of the pipe-shaped body 1. A sealing ring 3, a gasket 4, a circlip 5 and a covering ring 6 are sequentially mounted in the mounting pipe 2. The covering ring 6 is fixed in the mounting pipe 2, and the covering ring 6 is sleeved on an unlocking cylinder 7 such that the unlocking cylinder 7 is slidable relative to the covering ring 6.

A stepped ring 21 coaxially extends from one end of the mounting pipe 2 that is close to the pipe-shaped body 1, the sealing ring 3 is embedded with the stepped ring 21, and a diameter of the sealing ring 3 is greater than a length of the stepped ring 21 in its axis direction. When the quick-connect structure is assembled, the stepped ring 21 abuts against and supports the gasket 4, so as to ensure that the gasket 4 supports the circlip 5, and the gasket 4 presses against the sealing ring 3, so as to ensure that the sealing ring 3 is pressed to be fixed in the mounting pipe 2. When the pipe-shaped body 1 receives the pipe, the sealing ring 3 is pressed stably outside the pipe so as to improve the sealing between the sealing ring 3 and the pipe.

In addition, a fixing ring 63 extends coaxially on an outer periphery of the covering ring 6 at an end that is far away from the mounting pipe 2 with a chamfer being disposed at one end of the fixing ring 63 facing the mounting pipe 2. When the covering ring 6 is fixed to the mounting pipe 2, the covering ring 6 is partially embedded in the mounting pipe 2 until the fixing ring 63 abuts against the mounting pipe 2, and then the fixing ring 63 and the mounting pipe 2 are fixed to each other by welding, so as to achieve the fixed connection between the covering ring 6 and the mounting pipe 2.

A stopping ring 61 coaxially extends on an inner side of the covering ring 6 at one end that is far away from the circlip 5. An abutting ring 71 extends coaxially on an outer side of the unlocking cylinder 7 with a chamfer being disposed at one end of the abutting ring 71 facing the pipe-shaped body 1, and at the same time, a pushing ring 72 extends coaxially on the outer side of the unlocking cylinder 7 at one end that is away from the pipe-shaped body 1 and that is outside the mounting pipe 2. When the unlocking cylinder 7 is mounted, the pushing ring 72 is pushed such that the abutting ring 71 presses against the stopping ring 61, and the unlocking cylinder 7 is embedded in the covering ring 6 under the pressing force acting on the unlocking cylinder 7 as the plastic material has good elastic deformation ability within a certain range and the guidance of the chamfer of the abutting ring 71. When the unlocking cylinder 7 is pulled out of the covering ring 6, the stopping ring 61 stops the abutting ring 71, thereby achieving stable mounting of the unlocking cylinder 7 in the covering ring 6, and the pushing ring 72 of the unlocking cylinder 7 located outside the covering ring 6 facilitates pushing of the unlocking cylinder 7 during the subsequent disassembly of the pipe by hand so as to facilitate the disassembly of the pipe.

In addition, an arc chamfer 73 is disposed on the outside of the unlocking cylinder 7 at one end thereof close to the circlip 5, and a length of an arc of the arc chamfer 73 corresponds to an angle of 90°. When the pipe needs to be disassembled, the unlocking cylinder 7 is pressed to slide toward the covering ring 6. First, the arc chamfer 73 of the unlocking cylinder 7 abuts against the circlip 5, and the circlip 5 is gradually bent and opened as the unlocking cylinder 7 gradually slides into the covering ring 6 until the circlip 5 is bent to abut against the abutting ring 71. At the same time, the circlip 5 is separated from the arc chamfer 73 of the unlocking cylinder 7, such that a force arm for pushing the circlip 5 to rotate by the unlocking cylinder 7 is instantly reduced, and then force required for pushing the unlocking cylinder 7 is suddenly increased, that is, a person pushing the unlocking cylinder 7 knows that the pushing of the unlocking cylinder 7 is completed by a sudden change in the force acting on the hand, thereby avoiding excessive pushing of the unlocking cylinder 7 which ensures a service life of the circlip 5.

A chamfer is disposed on the inside of the unlocking cylinder 7 at one end thereof that is far away from the pipe-shaped body 1. A positioning ring 11 extends coaxially in an inner wall of the pipe-shaped body 1 and is located on one side of the sealing ring 3 that is far away from the gasket 4. When the pipe 2 is assembled, the pipe is inserted into the unlocking cylinder 7, and the chamfer of the unlocking cylinder 7 facilitates guiding an axis of the pipe to coincide with an axis of the unlocking cylinder 7, so as to facilitate the insertion of the pipe until the pipe is inserted to abut against the positioning ring 11 which determines the insertion depth of the pipe, thereby ensuring the stability of the connection between the pipe and the pipe-shaped body 1.

The implementation principle of this embodiment is as follows. When the pipe 2 is assembled, the pipe is inserted into the unlocking cylinder 7 until it abuts against the positioning ring 11, so as to ensure the sealing between the pipe and the pipe-shaped body 1. When the pipe is disassembled, the pushing ring 72 is manually pushed until the circlip 5 presses against the abutting ring 71, the force required for pushing the unlocking cylinder 7 is suddenly increased, and then the pipe is pulled out of the unlocking cylinder 7, thereby ensuring the smooth disassembly of the pipe.

Differences Between Embodiment Two and Embodiment One are as Follows

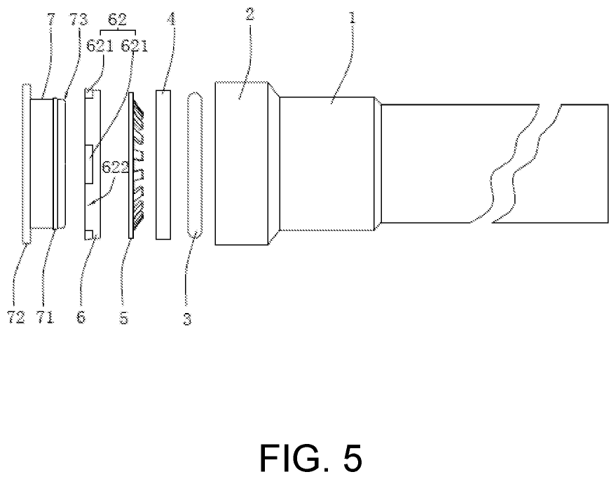

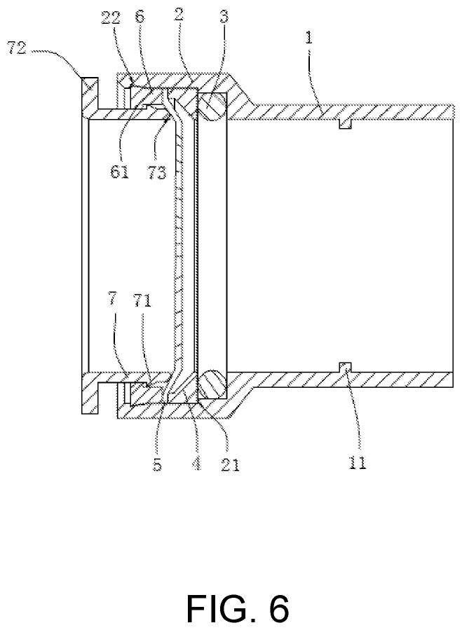

As shown in FIG. 5 and FIG. 6, the mounting pipe 2 has an engaging slot 22 disposed on the inside of the mounting pipe 2 at one end that is far away from the pipe-shaped body 1. A limit ring 62 coaxially extends on the outside of the covering ring 6 at one end that is far away from the circlip 5 with a chamfer disposed at one end of the limit ring 62 facing the pipe-shaped body 1, such that the cross section of the limit ring 62 assumes a right triangle in the plane of its axis. A chamfer is disposed on the inside of the mounting pipe 2 at one end that is far away from the pipe-shaped body 1. When the covering ring 6 is mounted, as the plastic material has good elastic deformation ability within a certain range, the covering ring 6 is directly pressed to move toward the mounting pipe 2, the chamfer of the mounting pipe 2 facilitates guiding an axis of the covering ring 6 to coincide with an axis of the mounting pipe 2, and the chamfer of the limit ring 62 guides the covering ring 6 to be embedded into the mounting pipe 2, thereby achieving the stable mounting of the mounting pipe 2. The limit ring 62 includes limit strips 621 spaced apart in a circumferential direction, and force-reducing grooves are formed between the limit strips 621 and reduce the area of resistance acting on the covering ring 6 when the covering ring 6 is mounted in the mounting pipe 2, thereby facilitating the mounting of the covering ring 6.

What is provided above is merely some preferred embodiments of this application. The scope of this application is not limited by the above embodiments, but should include all technical solutions under the thinking of this application. It is to be noted that, some improvements and modifications can be made by those skilled in the art without departing from the principle of this application, and should be considered to fall within the scope of this application.

What is claimed is:

1. A quick connector for a plastic pipe, the quick connector comprising a pipe-shaped body, wherein:
a quick-connect structure is disposed at at least one end of the pipe-shaped body in an axis direction,
the quick-connect structure comprises a mounting pipe integrally formed with the pipe-shaped body, and a sealing ring, a gasket, a circlip and a covering ring sequentially disposed in the mounting pipe,
the sealing ring is pressed to be fixed between the pipe-shaped body and the gasket, the covering ring is fixedly disposed in the mounting pipe,
a stopping ring coaxially extends on an inner side of the covering ring,
the stopping ring is sleeved on an unlocking cylinder such that the unlocking cylinder is slidable relative to the stopping ring, an abutting ring coaxially extends on an outer wall of the unlocking cylinder with a chamfer being disposed at one end of the abutting ring facing the pipe-shaped body, and
a pushing ring extends coaxially on the outer wall of the unlocking cylinder at one end of the unlocking cylinder that is outside the mounting pipe.

2. The quick connector for the plastic pipe according to claim 1, wherein:
a stepped ring which abuts against the gasket coaxially extends on an inner wall of the mounting pipe at one end thereof close to the pipe-shaped body,
the inner wall of the mounting pipe has an engaging slot located at one end of the mounting pipe that is far away from the pipe-shaped body, and
a limit ring engaging with the engaging slot is disposed on an outer periphery of the covering ring with a chamfer disposed at one end of the limit ring facing the pipe-shaped body.

3. The quick connector for the plastic pipe according to claim 2, wherein a chamfer is disposed on an inside of the end of the mounting pipe that is far away from the pipe-shaped body.

4. The quick connector for the plastic pipe according to claim 2, wherein the limit ring comprises limit strips spaced apart in a circumferential direction, and force-reducing grooves are formed between the limit strips.

5. The quick connector for the plastic pipe according to claim 2, wherein a diameter of the sealing ring is greater than a length of the stepped ring in the axis direction.

6. The quick connector for the plastic pipe according to claim 1, wherein an arc chamfer is disposed on an outside of the unlocking cylinder at one end thereof close to the circlip.

7. The quick connector for the plastic pipe according to claim 1, wherein a chamfer is disposed on an inside of the unlocking cylinder at one end thereof that is far away from the mounting pipe.

8. The quick connector for the plastic pipe according to claim 1, wherein a positioning ring extends coaxially on an inside of the pipe-shaped body.

9. The quick connector for the plastic pipe according to claim 1, wherein the quick-connect structures are disposed on both ends of the pipe-shaped body in the axis direction, and the pipe-shaped body is bent.

10. The quick connector for the plastic pipe according to claim 1, wherein a fixing ring extends coaxially on an outside of the covering ring with a chamfer being disposed at one end of the fixing ring facing the mounting pipe, the covering ring is embedded in the mounting pipe, the fixing ring abuts against the mounting pipe, and the fixing ring and the mounting pipe are fixed to each other by welding.
